(19) United States
(12) Patent Application Publication
(10) Pub. No.: US 2016/0059242 A1
(43) Pub. Date: Mar. 3, 2016

(54) Handshower Head Holder

(71) Applicant: Sun Kyu BAE, (US)

(72) Inventor: Sun Kyu Bae, Changwon-si (KR)

(21) Appl. No.: 14/784,521

(22) PCT Filed: Sep. 15, 2014
(86) PCT No.: PCT/KR2014/008582

§ 371 Date: Oct. 14, 2015

(30) Foreign Application Priority Data
Oct. 11, 2013 (KR) 10-2013-0121084
Nov. 25, 2013 (KR) 10-2013-0144007
Nov. 26, 2013 (KR) 10-2013-0144757

(51) Int. Cl. B05B 1/18; G01K 11/18; B05B 15/06

(52) U.S. Cl. CPC B05B 1/185; B05B 15/061; G01K 11/18

(57) ABSTRACT

The present invention relates to a handshower head holder capable of fixing and holding a handshower head, wherein a user can place a handshower holder at a desired position when using a handshower and can hold a handshower head regardless of the place such that the user can easily hold the handshower head without the handshower head being turned over when the user has difficulty in locking the handshower while washing a baby or a child, an elderly person, or a handicapped person or when cleaning the bathroom or hand-washing and the like. Furthermore, since the handshower head is capable of being fixed even by various types of handshowers, weight, and water pressure, it is possible to stably receive eater without a handshower turning over even when the handshower is submerged under water.

### TECHNICAL FIELD

The present invention relates to a handshower head holder and, more particularly, to a handshower head holder that is disposed on the floor or on the bottom of a tub capable of keeping water and prevents a handshower head holder inserted in a protection cap from moving due to discharged hydraulic pressure

Further, the present invention relates to a handshower head holder that can fixedly hold a handshower head due to water pressure in the handshower when a user draws water in a bathtub or a basin with the handshower therein or on the floor while the user uses the handshower head, and that can indicate the temperature of water ejected from the handshower head, using a change in color.

### BACKGROUND ART

In general, when a user repeats turning on/off water to take a shower or put water into a bathtub or a basin using a handshower, the handshower head is randomly moved by water pressure and water splashes to undesired places in many cases.

Further, when people bathe infants, elderly people, and disabled people, they use a handshower with the water turned on and place the handshower on the floor of a bathroom or in a bathtub for a short time, but it is difficult to fix the handshower due to water pressure.

Handshower holders that are supposed to be attached on a wall are typically installed high, so when users use the handshower holders while wearing clothes, their clothes get wet by the water dropping from the high positions and splashing up.

Further, parents or the like who help children bathe using a wall-mounted handshower generally get wet clothes. In addition, the parent has to repeat sitting and standing up to mount/unmount handshowers from wall-mounted holders.

Further, when users use hot water on cold days, they operate a temperature control bar of the handshower to set an appropriate temperature, but they cannot use the handshower immediately and have to wait until the appropriate temperature is reached.

In association with this problem, a washbowl with a holder of a shower head has been disclosed in Korean Utility Model No. 20-0426042, in which a holder for holding a shower head is disposed on the upper edge of a washbowl, but the shower holder cannot be held on other basins except for the washbowl with the shower holder. Further, when a parent uses the shower head with a child in his/her arms, he/she has to push the shower head with a predetermined force in order to fix the shower head to the holder on the washbowl, so when a user fixes the shower head on the holder with one hand, the washbowl is pushed to a side.

Further, when a handshower head is held on a wall-mounted handshower holder commonly used to get water, the direction of ejected water is fixed, so the handshower can be used only in the direction of the ejected water.

In order to solve these problems, a ‘shower holder’ disclosed in Korean Utility Model Application Publication No. 2012-0006991 is configured to be able to control an angle up/down and left/right, so it is possible to easily control the angle of water ejected from a shower head in accordance with the conditions of users.

Further, since the shower head is fixed, the shower head is prevented from randomly moving due to water pressure.

However, shower holders of the related art can be installed at places with flat surfaces and handshower heads can be held only at the positions of the handshower holders, so it is required to remove handshower holders from the positions and then reinstall them in order to move the handshower holder to other positions.

Further, when there is water or dirt on a wall, those handshower holders of the related art are easily detached because the bonding force is small, and they are naturally detached by their weight after a long period of time passes.

Further, users have to get their hands wet with water ejected from a handshower holder in order to check the temperature of the water or set the water to an appropriate temperature.

### DISCLOSURE

### Technical Problem

Accordingly, the present invention has been made keeping in mind the above problems occurring in the related art, and the present invention is intended to propose a handshower holder that can be installed on the floor or the bottom of a tub and prevents movement of a handshower head due to water pressure.

Further, the present invention provides a handshower head holder that prevents a handshower head from moving in or separating from a protection cap by smoothly discharging water from the handshower head to the outside.

Further, the present invention provides a handshower head holder that can fixedly hold a handshower head due to water pressure in the handshower when a user draws water in a bathtub or a basin with the handshower therein or on the floor while the user uses the handshower head, and that indicates the temperature of water ejected from the handshower head, using a change in color.

### Technical Solution

In order to achieve the above object, according to one aspect of the present invention, there is provided a handshower head holder including: a base having an outer diameter larger than an outer diameter of a handshower head and shaped to correspond to the handshower head; and a protective portion formed in the shape of a dome with a side open over the base and preventing the handshower head inserted in a space inside the dome from being separated, in which at least one water hole is formed through a top of the base to discharge water, which is ejected from the handshower head, through a bottom of the base to reduce pressure of the water ejected from the handshower head from an inside of the protective portion.

A plurality of projections for smoothly discharging water that is discharged through the bottom of the base by the first water hole may be further formed on the bottom of the base.

The protection cap may have wire meshes or at least one second water hole to easily discharge the water, which is ejected from the handshower head, to the outside of the protection cap.

A cross-section of the protection cap may be inclined toward a closed side to easily insert and separate the handshower head.

Fixing members may be further disposed on the bottom of the base to be easily fixed to a floor or a bottom of a tub.

Further, in order to achieve the above object, according to one aspect of the present invention, there is provided a handshower head holder including: a rest having a seating groove shaped to a handshower head and retaining the handshower head; a first drain mechanism formed in the rest to discharge water ejected from the handshower head seated in the seating groove; a support formed at a side of a bottom of the rest to define a space for discharging water from the first drain mechanism and functioning as a hook; and a cover having an inlet for inserting the handshower head and formed over the rest to cover a portion of the rest in order to prevent separation of the handshower head and splashing of water due to water pressure.

Further, in order to achieve the above object, according to one aspect of the present invention, there is provided a handshower head holder including: a rest having a seating groove shaped to a handshower head and retaining the handshower head; a first drain mechanism formed in the rest to discharge water ejected from the handshower head seated in the seating groove; a support formed at a side of a bottom of the rest to define a space for discharging water from the first drain mechanism and functioning as a hook; a cover having an inlet for inserting the handshower head and formed over the rest to cover a portion of the rest in order to prevent separation of the handshower head and splashing of water due to water pressure; and a temperature indicator formed on the rest and changing color in accordance with the temperature of water.

A plurality of protrusions may be formed at the same height as the support with regular intervals around an edge of the bottom of the rest.

The rest may have an inclined surface formed toward the inlet.

The first drain mechanism may have a first hole formed at a center portion of the seating groove of the rest and a plurality of second holes formed around the first hole.

Creases may be formed on the bottom of the rest.

Two or more creases may be formed on the rest in a direction where the handshower head is seated.

A protective surface may be formed perpendicular to the rest at a predetermined height, at a front of the cover.

A blocking flange may be formed along an edge of an upper end of the cover where the inlet is formed.

Second drain holes may be formed at a lower portion of the cover.

The second drain holes may be formed in such a manner that one drain hole is formed at a center and at a side of the lower portion of the cover, respectively.

An image insertion portion may be formed at a side of a surface of the cover.

The rest, the cover, and the support may be made of any one of or a mixture of two or more of silicon, plastic, and FRP.

The temperature indicator may be formed by applying reversible thermo ink on a surface of the rest.

The temperature indicator may be formed by the reversible thermo ink that is mixed when the rest is injection-molded.

### Advantageous Effects

According to the present invention, the condensed water discharging apparatus is disposed on the ground or the bottom of a tub and prevents movement of a handshower head due to water pressure.

Further, it is possible to prevent a handshower head from moving in or separating from a protective cap by smoothly discharging water from the handshower head to the outside.

Further, according to the present invention, a user can place a handshower holder at a desired position when using a handshower and can hold a handshower head regardless of the place.

Further, a user can easily hold the handshower head without the handshower head being turned over when the user has difficulty in locking the handshower while washing a baby or a child, an elderly person, or a handicapped person or when cleaning the bathroom, hand-washing, and the like.

Further, it is possible to prevent inconvenience that a user has to set the temperature of water to an appropriate level again when he/she turned off the water after using hot water on a cold day.

Furthermore, since the handshower head is capable of fixing various types of handshowers with different weights and water pressures, it is possible to stably receive water without a handshower turning over even when the handshower is submerged in water.

Further, a user can recognize the temperature of water from a color that changes in accordance with the temperature of water ejected from a handshower head held by the handshower head holder, so it is convenient to use a handshower.

### DESCRIPTION OF DRAWINGS

FIG. 1 is a perspective view showing a handshower head holder according to a first embodiment of the present invention;

FIG. 2 is a plan view of the handshower head holder shown in FIG. 1;

FIG. 3 is a side view of the handshower head holder shown in FIG. 1;

FIG. 4 is a side view showing a protection cap for the handshower head holder according to the first embodiment of the present invention;

FIG. 5 is a side view showing fixing members for the handshower head holder according to the first embodiment of the present invention;

FIG. 6 is a perspective view showing a handshower head holder according to a second embodiment of the present invention;

FIG. 7 is a cross-sectional view showing the second embodiment of the present invention;

FIG. 8 is a plan view showing a rest of the second embodiment of the present invention;

FIG. 9 is a bottom view showing the rest of the second embodiment of the present invention;

FIG. 10 is a cross-sectional view showing a third embodiment of the present invention;

FIG. 11 is a plan view showing a rest of the third embodiment of the present invention;

FIG. 12 is a perspective view showing a handshower head holder according to a fourth embodiment of the present invention;

FIG. 13 is a cross-sectional view showing the fourth embodiment of the present invention;

FIG. 14 is a plan view showing a rest of the fourth embodiment of the present invention;

FIG. 15 is a bottom view showing the rest of the fourth embodiment of the present invention;

FIG. 16 is a cross-sectional view showing a fifth embodiment of the present invention; and

FIG. 17 is a plan view showing a rest of the fifth embodiment of the present invention.

### MODE FOR INVENTION

Details including the objects, solutions for the objects, and effects of the present invention are included in the following embodiments and the drawings. The advantages and features of the present invention, and methods of achieving them will be clear by referring to the exemplary embodiments that will be described hereafter in detail with reference to the accompanying drawings.

Hereinafter, handshower head holders of the present invention will be described with reference to the accompanying drawings.

### FIRST EMBODIMENT

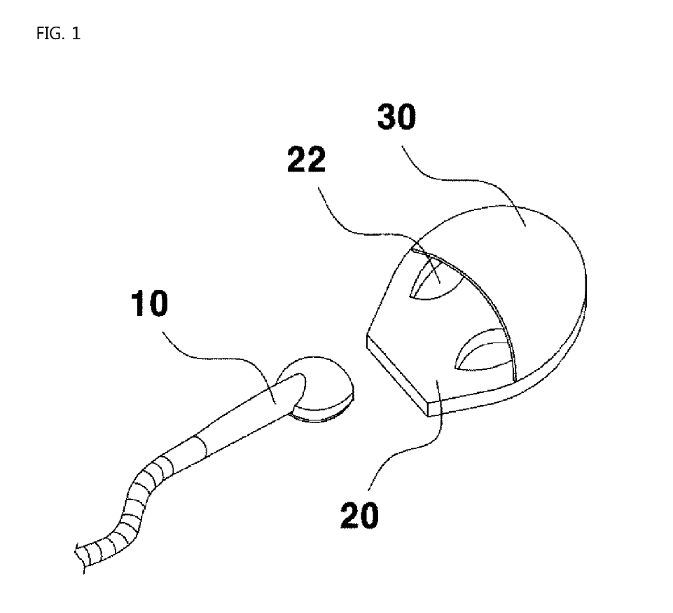

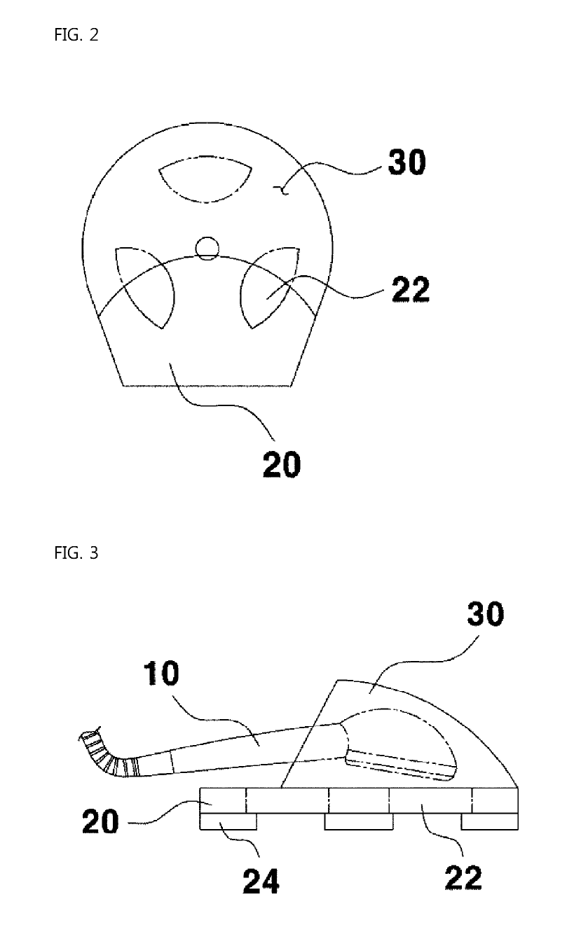

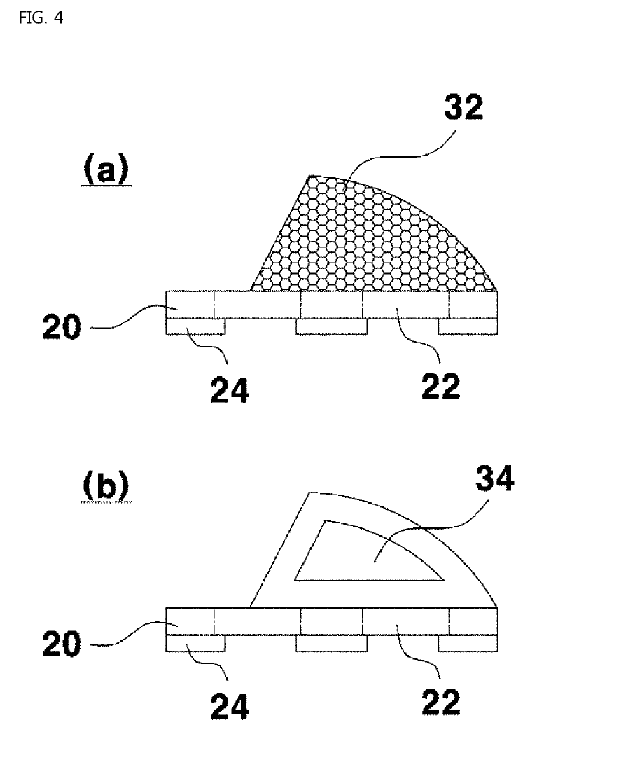

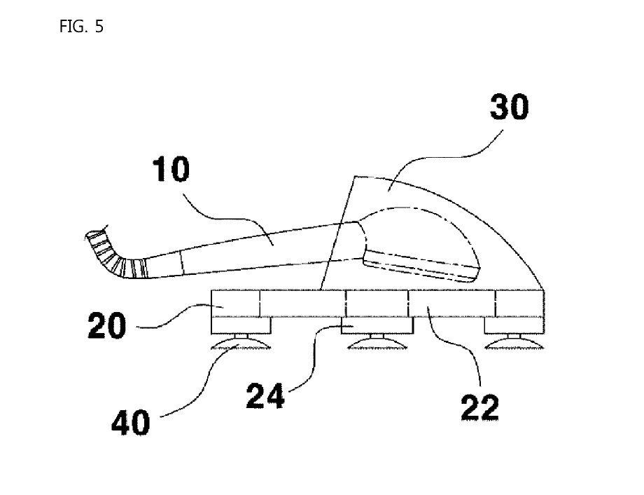

FIG. 1 is a perspective view showing a handshower head holder according to a first embodiment of the present invention, FIG. 2 is a plan view of the handshower head holder shown in FIG. 1, and FIG. 3 is a side view of the handshower head holder shown in FIG. 1.

A handshower head holder of the present invention includes a base 20 having an outer diameter larger than that of a handshower head 10 and shaped to correspond to the handshower head 10, a protective portion formed in the shape of a dome with a side open over the base 20, and first water holes 22 formed through the top of the base 20 to discharge water ejected from the handshower head 10 through the bottom of the base 20.

First, the base 20 is provided for the handshower head holder of the present invention. The base 20 is larger in outer diameter than the handshower head 10 and shaped to correspond to the handshower head 10. That is, the base 20 has an outer diameter larger than that of the handshower head 10 to be able to keep the handshower head 10, so it can stably retain the handshower head 10. Accordingly, the base 20 keeps the handshower head 10 in contact with the floor in an area larger than the outer diameter of the handshower head 10, so the base 20 is prevented from being turned over due to water pressure from the handshower head 10.

Further, the base 20 has predetermined thickness and weight, so it can effectively prevent turning-over due to the water pressure from the handshower head 10.

The protective portion is formed at the upper end of the base 20. The protective portion is formed in the shape of a dome with a side open at the upper end of the base 20. That is, the protective portion is formed in the shape of a dome in which the gap between the top of the base 20 and the bottom of the protective portion decreases, as it goes to the center of the base 20, so a space where the handshower head 10 can be stably retained is formed. The dome-shaped protective portion allows the handshower head 10 to be kept inside a protection cap 30, prevents the handshower head 10 from moving due to water pressure when water is ejected from the handshower head 10 seated inside the protection cap 30, and prevents the handshower head 10 from being separated from the upper end of the base 20.

The first water holes 22 are formed through the top of the base 20. At least one first water hole 22 is formed through the top of the base 20 to discharge water ejected from the handshower head 10 through the bottom of the base 20. That is, the first water holes 22 are formed through the base 20 and discharges water ejected from the handshower head 10 seated inside the protection cap 30 through the bottom of the base 20. Accordingly, water is discharged through the bottom of the base 20 by the first water holes, so water pressure applied to the base 20 and the protection cap 30 is reduced.

Projections 24 are formed on the bottom of the base 20. The projections 24 protrude on the bottom of the base 20 to ensure a space through which the water discharged through the first water holes 22 can flow to the outside. That is, a plurality of projections 24 protrudes on the bottom of the base 20 so that the water discharged through the first water holes 22 can be smoothly discharged outside through the bottom of the base 20.

The protection cap 30 may have wire meshes 32. That is, the protection cap 30 has the wire meshes 32, so the water discharged from the handshower head 10 inside the protection cap 30 is discharged outside the protection cap 30 and the water pressure inside the protection cap 30 is reduced.

Further, the protection cap 30 may have a second water hole 42. At least one second water hole is formed through the protection cap 30 to discharge the water inside the protection cap 30 to the outside. That is, similar to the wire meshes 32, the second water hole reduces the water pressure inside the protection cap 30 by discharging the water, which is discharged from the handshower head 10 inside the protection cap 30, to the outside of the protection cap 30.

The cross-section of the protection cap 30 is inclined, as it goes to the closed side of the protection cap 30. That is, the cross-section of the protection cap 30 is inclined toward the closed side of the protection cap 30, as it goes to the upper end so that the handshower head 10 can be easily inserted and taken out. Accordingly, when a user inserts the handshower head 10 inside the protection cap 30, the handshower head 10 can be easily inserted.

The fixing members 40 are formed on the bottom of the base 20. At least one fixing member 40 is disposed on the bottom of the base 20 or the bottom of the projections 24 and fixes the handshower head holder of the present invention to the floor or the bottom of tub. That is, the fixing members 40 are disposed on the bottom of the base 20 or the bottom of the projections 24 and fix the handshower head holder of the present invention on the floor or the bottom of a tub to prevent the handshower head holder from being turned over or moved by water pressure. The fixing members 40 may be fixed to a coated surface in an air pressure type to be fixed to a tile or the inner side of a basin.

Further, a position adjuster (not shown) is disposed on the bottom of the base 20.

The position adjuster enables the base 20 and the protection cap 30 can receive the curved shape of the handshower head 10, when the handshower head 10 is inserted inside the protection cap 30. That is, the position adjuster inclines upward the base 20 toward the open side from the closed side of the protective case 30 with respect to the floor where the base 20 is installed. Accordingly, an inclined surface is formed so that the water-discharging side of the handshower head 10 is brought in close contact with the lower end of the base 20, so water can be smoothly discharged out of the base 20. Further, the shape of the handshower head 10 is received and the water-discharging side of the handshower head 10 is seated on the top of the base 20.

Further, the position adjuster allows handshowers to be detachably attached to the lower end of the base 20 in accordance with the types of the handshowers.

### SECOND AND THIRD EMBODIMENTS

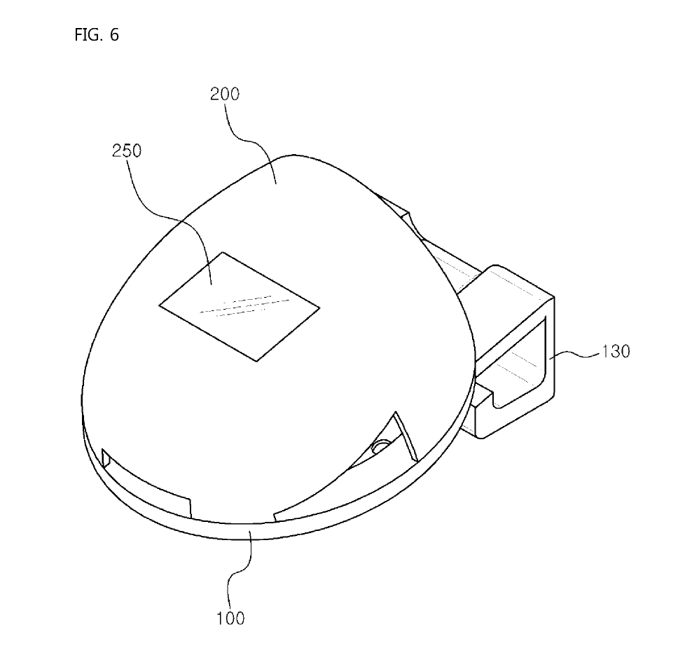

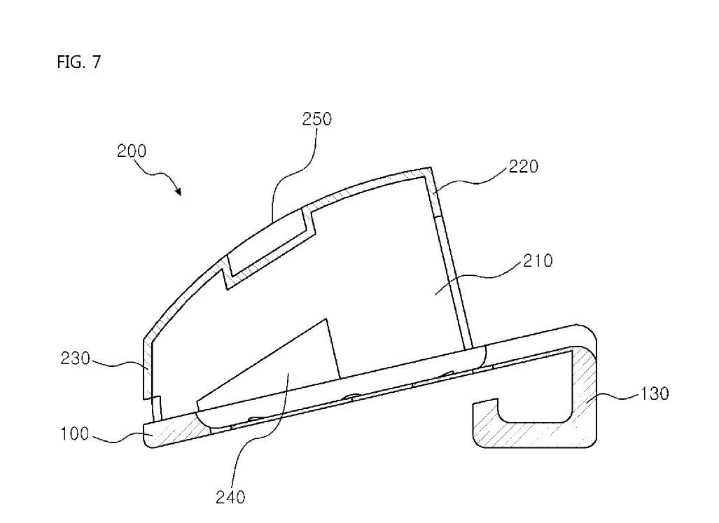

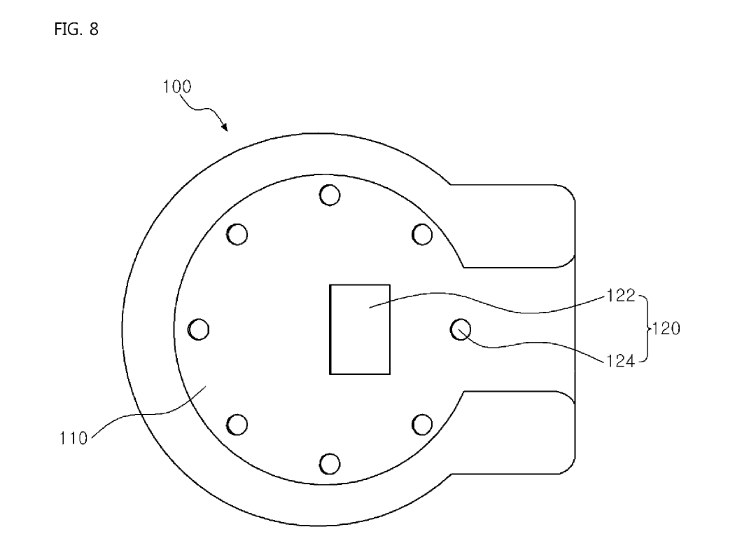

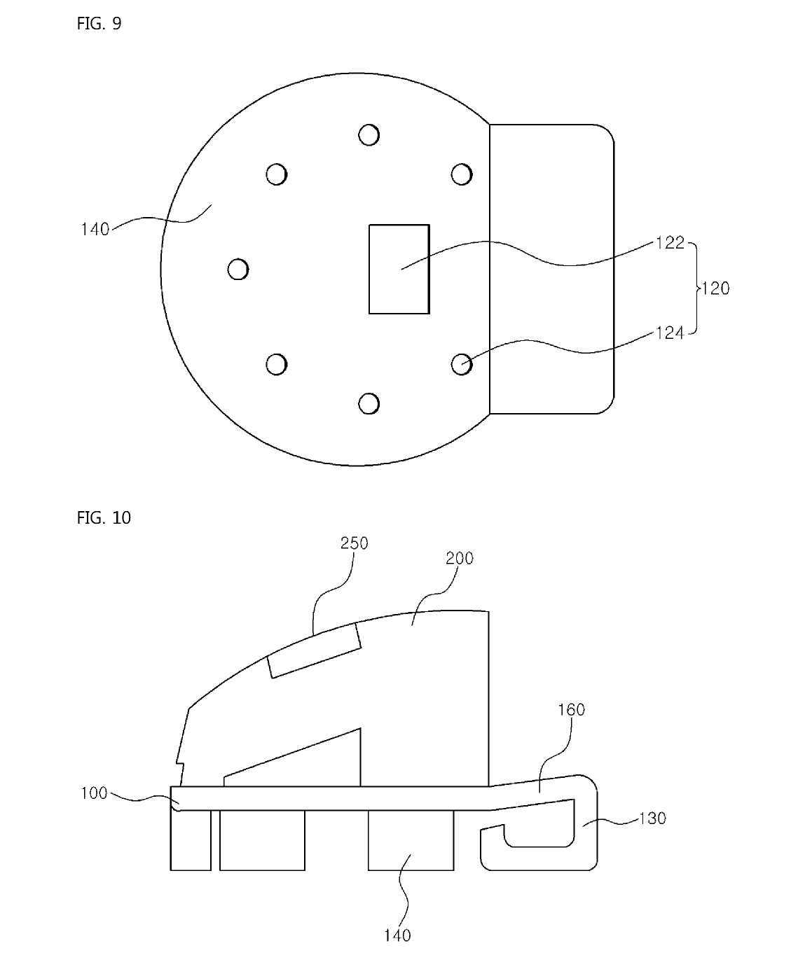

FIG. 6 is a perspective view showing a handshower head holder according to a second embodiment of the present invention, FIG. 7 is a cross-sectional view showing the second embodiment of the present invention, FIG. 8 is a plan view showing a rest of the second embodiment of the present invention, and FIG. 9 is a bottom view showing the rest of the second embodiment of the present invention.

A handshower head holder according to the embodiment of the present invention includes a rest 100, a first drain 120, a support 130, and a cover 200.

A handshower head is seated on the rest 100, and as shown in FIG. 6, a seating groove 110 shaped to correspond to the handshower head is formed on the rest 100. Since the seating groove 110 is formed, the handshower head can be positioned at the center, not inclining to the edge of the rest 100.

Further, the seating groove 110 is formed larger than the outer shape of the handshower head, so it can receive handshower heads having any sizes.

As shown in FIG. 3, the first drain 120 is formed in the rest 100 so that water discharged from a handshower head seated in the seating groove 110 is discharged.

Further, the first drain 120 is composed of a first hole 122 formed at the center portion of the seating groove 110 of the rest 100 and a plurality of second holes 124 formed around the first hole 122.

Further, one first hole 122 is formed at the center portion of the rest 100 to discharge the water ejected under the largest pressure directly from the handshower head and is formed smaller than the outer diameter of the handshower head so that the handshower head is not separated.

Further, the second holes 124 smaller than the inner diameter of the first hole 122 are formed with regular intervals around the first hole 122.

When the inner diameter of the second holes 124 is too small it causes poor drainage, but when the large inner diameter of the second holes 124 is too large it reduces the gaps between the second holes 124, so the support ability of durability of the rest 100 may be reduced. Accordingly, it is preferable to determine the number and the inner diameter of the second holes 124 in consideration of the inner diameter of the first hole 122.

In the embodiment of the present invention, one first hole 122 is formed, but a plurality of holes may be formed at the position where the handshower head is seated, as long as the structure can drain well.

As shown in FIG. 7, the support 130 is formed at a side of the bottom of the rest 100 so that the rest 100 is inclined to define a space for discharging water from the first drain 120.

The handshower head holder can be placed on the floor by the support 130 and the support 130 may function as hook, which is substantially U-shaped, as shown in FIG. 7. For example, it is possible to hang the support 130 on the edge of a washbowl or a baby bathtub, and the handshower head holder can be stably held by hanging the support 130. Further, the handshower head holder can be hung on a towel rail, so it can be used for accommodating various objects.

Further, as shown in FIG. 10, a plurality of protrusions 140 is formed at the same height as the support 130 with regular intervals along the edge of the bottom of the rest 100, so spaces can be defined so that water can be discharged from the first drain mechanism 120.

In the third embodiment of the present invention, five projections 140 are formed with regular intervals so that the rest 100 can be balanced on the ground, but they may be formed in any shapes and any sizes, as long as the structure can balance the rest 100 such that the rest 100 is not turned over.

An inclined surface 160 is formed on the rest 100 toward an inlet 210 of the rest 100 so that the handshower head can be easily inserted and taken out.

The inclined surface 160 enables a user to more easily and conveniently insert the handshower head into the inlet and seated on the rest 100.

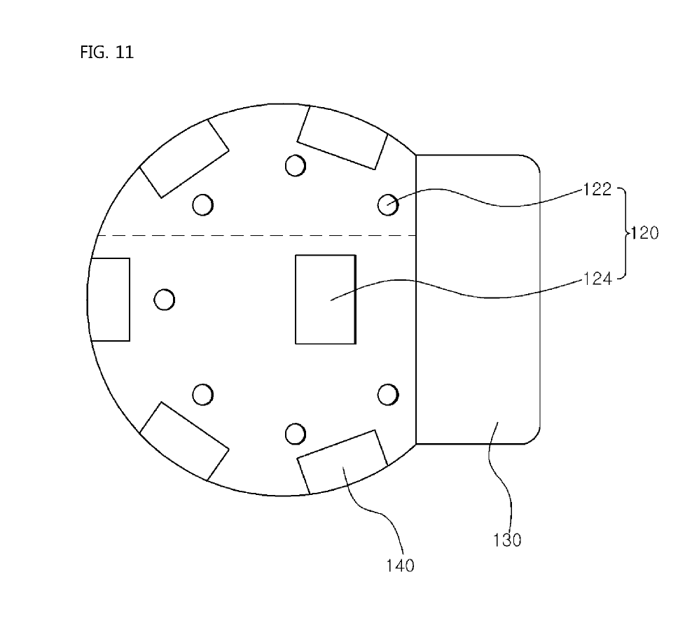

As shown in FIGS. 9 and 11, creases 150 are formed on the rest 100 to change the height of a portion of the rest 100.

The creases 150 allow the rest 100 to be placed on a curved surface such as the edge of a bathtub or a washbasin, so a user can use the handshower head holder of the present invention regardless of a place and a position.

In the embodiment of the present invention, two creases 150 are formed on the rest 100 in the direction in which the handshower head is seated, but two or more creases may be formed, depending on the size or the material of the rest 100.

The inlet 210 is formed to insert the handshower head and the cover 200 is formed in the shape of a dome at the upper end of the rest 100 to cover a portion of the rest 100.

The cover 200 prevents the handshower head from being moved and separated from the rest 100 by water pressure when water is ejected from the handshower head, thereby preventing water from splashing on a user.

A protective surface 230 is formed at a predetermined height perpendicular to the rest 100 at the front of the cover 200 so that the handshower head is not locked in the inside of the cover 200 when it is inserted.

The height of the protective surface 230 may depend on the shape of the cover 200.

In other words, it is preferable that when the curvature of the cover 200 formed in the shape of a dome is large, the height of the protective surface 230 may be relatively small, and when the curvature of the cover 200 is gentle, the height of the protective surface 230 is large.

However, the cover may be formed in any shape unless it locks and interferes with a handshower head when the handshower head is inserted.

In the present invention, a blocking flange 220 is formed along the edge of the upper end of the cover 200 where the inlet 210 is formed. The blocking flange 220 prevents the handshower head from being separated from the inlet 210 by water pressure and prevents water from flashing to a user.

Further, a plurality of second drain holes is formed at the lower portion of the cover 200, and in the embodiment of the present invention, one second drain hole is formed at the center and at a side of the lower portion of the cover 200.

The rest 100, the cover 200, and the support 130 are made of any one or more of silicon, plastic, and FRP and have predetermined thickness and weight to prevent the handshower head from being turned over by water pressure and from being moved in water when a user gets water in a container.

An image insertion portion 250 is formed at a side of the surface of the cover 200 so that a user can insert an image such as a picture in accordance with his/her taste and preference.

### FOURTH AND FIFTH EMBODIMENTS

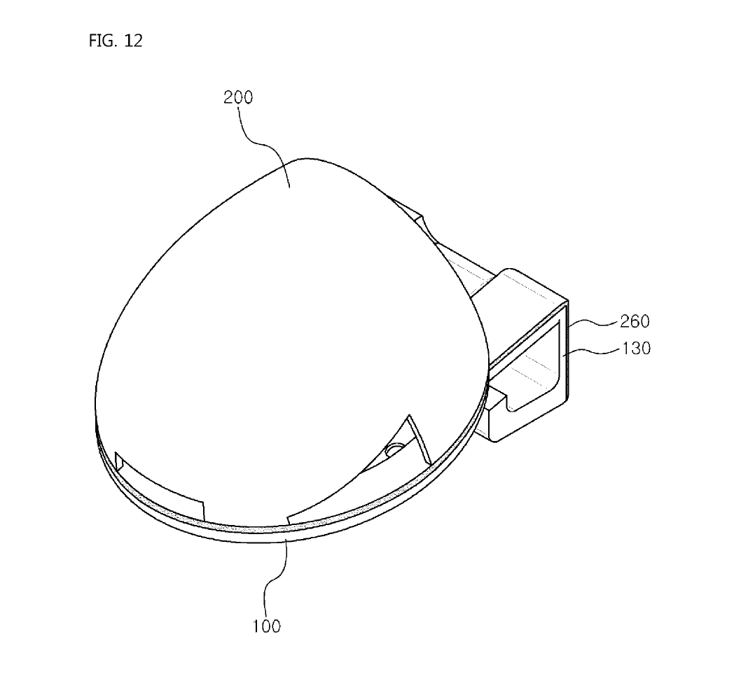

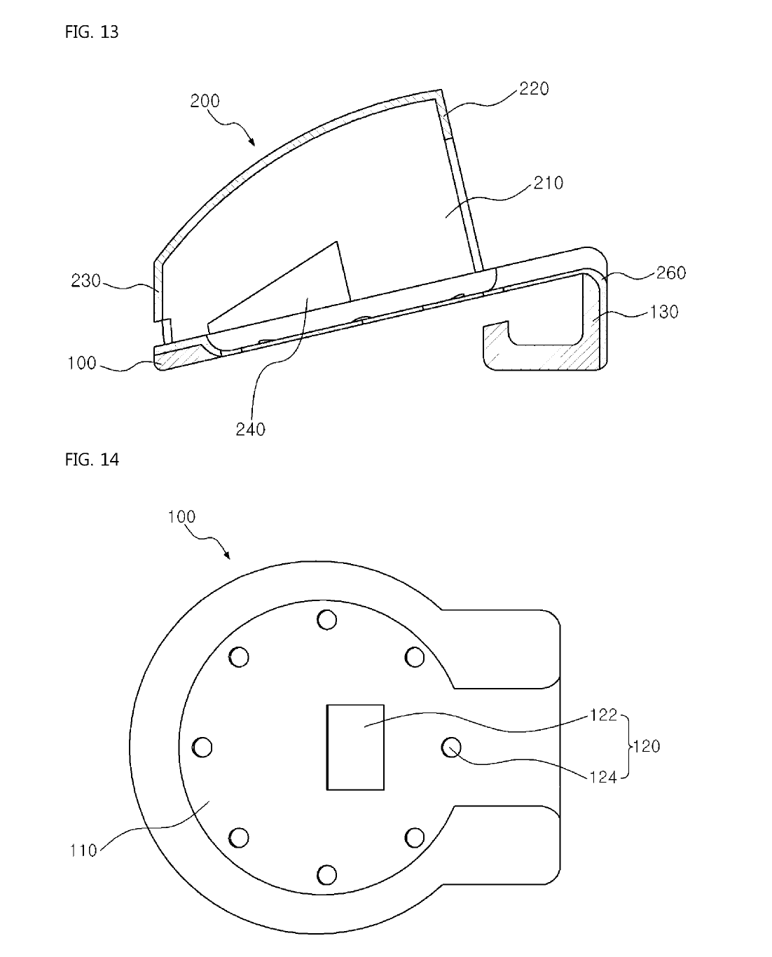

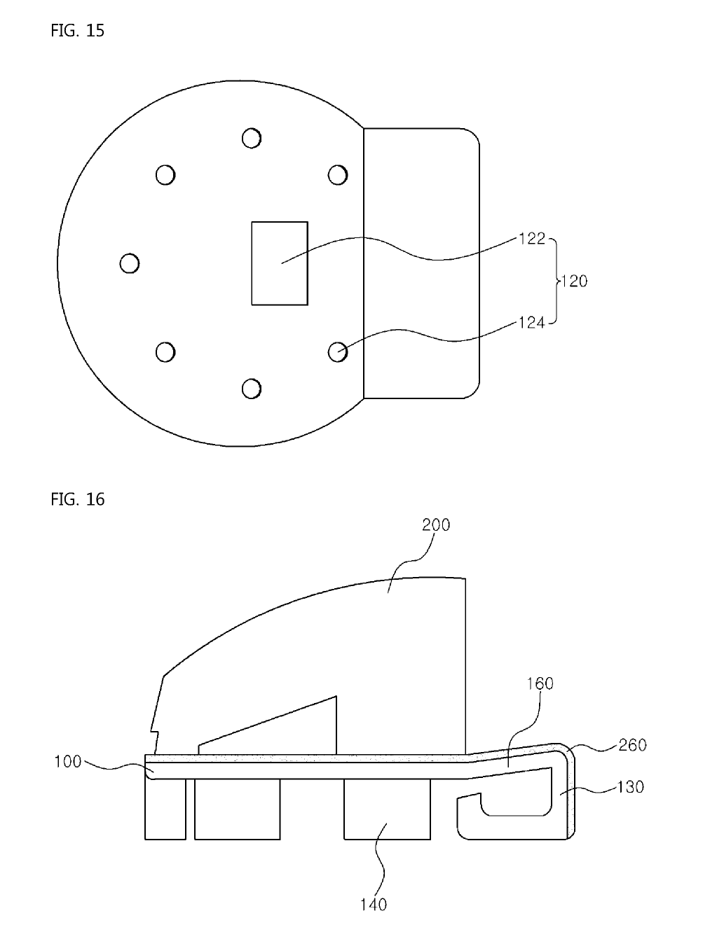

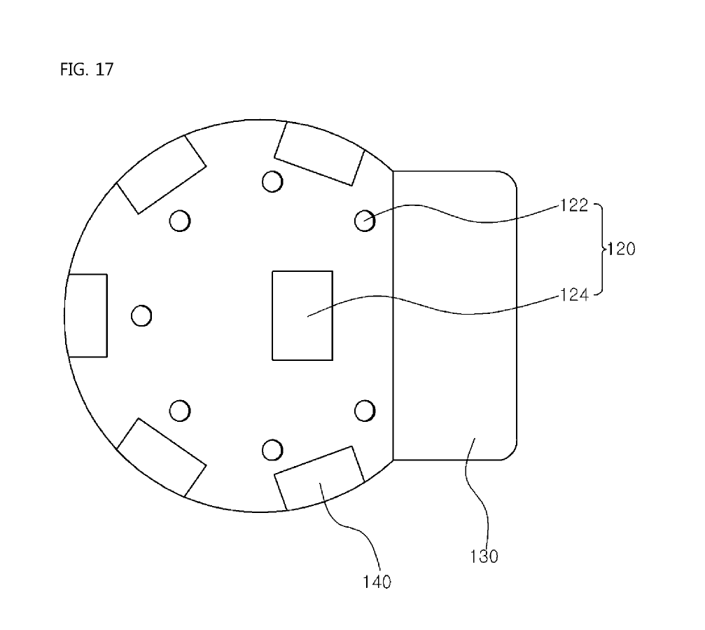

FIG. 12 is a perspective view showing a handshower head holder according to a fourth embodiment of the present invention, FIG. 13 is a cross-sectional view showing the fourth embodiment of the present invention, FIG. 14 is a plan view showing a rest of the fourth embodiment of the present invention, and FIG. 15 is a bottom view showing the rest of the fourth embodiment of the present invention.

A handshower head holder according to a fourth embodiment of the present invention includes a rest 100, a first drain mechanism 120, a support 130, and a temperature indicator 260 and the components described with reference to the second embodiment are not described here.

According to the fourth embodiment of the present invention, the temperature indicator 260 that changes color in accordance with the temperature of water is formed on the rest 100 so that a user can recognize the temperature of water ejected from the handshower head held on the handshower head holder in use.

In the embodiment of the present invention, the temperature indicator 260 is formed on the top of the rest 100 by applying reversible thermo ink on the surface of the rest 100.

Further, the temperature indicator 260 is formed by reversible thermo ink and a material such as silicon, plastic, and FRP that are mixed when a material such as silicon, plastic, FRP is injection-molded to form the rest 100, the cover 200, and the support 130.

The temperature indicator 260 sets a reference temperature within the range of −15° C.-70° C., and keeps the color of the ink under the reference temperature, but becomes transparent when the reference temperature is reached, or remains being transparent under the reference temperature and then becomes colored when the reference temperature is reached.

Although exemplary embodiments of the present invention were described and shown, the present invention is not limited to specific embodiments and may be modified in various ways by those skilled in the art without departing from the spirit of the present invention described in claims, and the modifications are included in claims.

### INDUSTRIAL APPLICABILITY

The handshower head holder of the present invention can hold a handshower head without a limit of a space, so it can provide convenience in daily life. Further, it has a simple configuration and can be easily manufactured, so it can be considered as having high industrial applicability.

1. A handshower head holder comprising:
a base having an outer diameter larger than an outer diameter of a handshower head and shaped to correspond to the handshower head; and
a protective portion formed in the shape of a dome with a side open over the base and preventing the handshower head inserted in a space inside the dome from being separated,
wherein at least one first water hole is formed through a top of the base to discharge water, which is ejected from the handshower head, through a bottom of the base to reduce pressure of the water ejected from the handshower head from an inside of the protective portion.

2. The handshower head holder of claim 1, wherein a plurality of projections for smoothly discharging water that is discharged through the bottom of the base by the first water hole is further formed on the bottom of the base.

3. The handshower head holder of claim 1, wherein the protection cap has wire meshes or at least one second water hole to easily discharge the water, which is ejected from the handshower head, to the outside of the protection cap.

4. The handshower head holder of claim 1, wherein a cross-section of the protection cap is inclined toward a closed side to easily insert and separate the handshower head.

5. The handshower head holder of claim 1, wherein fixing members are further disposed on the bottom of the base to be easily fixed to a floor or a bottom of a tub.

6. A handshower head holder comprising:
a rest having a seating groove shaped to a handshower head and retaining the handshower head;
a first drain mechanism formed in the rest to discharge water ejected from the handshower head seated in the seating groove;
a support formed at a side of a bottom of the rest to define a space for discharging water from the first drain mechanism and functioning as a hook; and
a cover having an inlet for inserting the handshower head and formed over the rest to cover a portion of the rest in order to prevent separation of the handshower head and splashing of water due to water pressure.

7. A handshower head holder comprising:
a rest having a seating groove shaped to a handshower head and retaining the handshower head;
a first drain mechanism formed in the rest to discharge water ejected from the handshower head seated in the seating groove;
a support formed at a side of a bottom of the rest to define a space for discharging water from the first drain mechanism and functioning as a hook;
a cover having an inlet for inserting the handshower head and formed over the rest to cover a portion of the rest in order to prevent separation of the handshower head and splashing of water due to water pressure; and a temperature indicator formed on the rest and changing a color in accordance with temperature of water.

8. The handshower head holder of claim 6, wherein a plurality of protrusions is formed at the same height as the support with regular intervals around an edge of the bottom of the rest.

9. The handshower head holder of claim 6, wherein the rest has an inclined surface formed toward the inlet.

10. The handshower head holder of claim 6, wherein the first drain mechanism has a first hole formed at a center portion of the seating groove of the rest and a plurality of second holes formed around the first hole.

11. The handshower head holder of claim 6, wherein creases are formed on the bottom of the rest.

12. The handshower head holder of claim 11, wherein two or more creases are formed on the rest in a direction where the handshower head is seated.

13. The handshower head holder of claim 6, wherein a protective surface is formed perpendicular to the rest at a predetermined height, at a front of the cover.

14. The handshower head holder of claim 6, wherein a blocking flange is formed along an edge of an upper end of the cover where the inlet is formed.

15. The handshower head holder of claim 6, wherein second drain holes are formed at a lower portion of the cover.

16. The handshower head holder of claim 15, wherein the second drain holes are formed in such a manner that one drain hole is formed at a center and at a side of the lower portion of the cover, respectively.

17. The handshower head holder of claim 6, wherein an image insertion portion is formed at a side of a surface of the cover.

18. The handshower head holder of claim 6, wherein the rest, the cover, and the support are made of any one of or a mixture of two or more of silicon, plastic, and FRP.

19. The handshower head holder of claim 7, wherein the temperature indicator is formed by applying reversible thermo ink on a surface of the rest.

20. The handshower head holder of claim 7, wherein the temperature indicator is formed by the reversible thermo ink that is mixed when the rest is injection-molded.
